(19) United States
(12) Patent Application Publication
(10) Pub. No.: US 2014/0297038 A1
(43) Pub. Date: Oct. 2, 2014

(54) NETWORK, CONTROL SYSTEM FOR CONTROLLING THE NETWORK, NETWORK APPARATUS FOR THE NETWORK, AND METHOD OF CONTROLLING THE NETWORK

(71) Applicants: NEC CORPORATION, Tokyo (JP); RAYTHEON BBN TECHNOLOGIES CORP., Cambridge, MA (US)

(72) Inventors: Itaru NISHIOKA, Tokyo (JP); Cesar A. SANTIVANEZ, Cambridge, MA (US)

(73) Assignees: Raytheon BBN Technologies Corp., Cambridge, MA (US); NEC Corporation, Tokyo (JP)

(21) Appl. No.: 13/853,771

(22) Filed: Mar. 29, 2013

(51) Int. Cl. G05B 15/02

(52) U.S. Cl. CPC G05B 15/02
USPC 700/275

(57) ABSTRACT

A control system for controlling a network including a plurality of network apparatuses, includes a network site controller for controlling a cooling system in the network and extracting network resource and ambient information from the plurality of network apparatuses into topological information, and a network controller for controlling the plurality of network apparatuses based on the topological information.

### BACKGROUND OF THE INVENTION

1. Field of the Invention

The present invention relates generally to a control system for a network and more particularly, to a control system for a network which includes a network controller and a network site controller.

2. Description of the Related Art

As cloud computing services and the Internet are more widely used, energy consumption in network systems is becoming a critical issue requiring continuous network upgrades in both capacity and processing power. Conventional research and product development attempts reduce energy consumption and improve energy efficiency in future network systems.

One conventional work includes traffic off-loading from packet-switched networks to wavelength-switched optical networks. A wavelength-switched optical networks is more power efficient than a packet-switched network, in terms of energy-per-bit, since wavelength optical switching does not require optical-to-electrical (O/E) and electrical-to-optical (E/O) processing at switching network devices. Therefore, it is more energy efficient to switch traffic at the optical layer without O/E and E/O processing.

One drawback to using such wavelength-switched optical networks is lower network resource utilization. Full mesh wavelength connections are required among network edge nodes and typical traffic demand between a pair of network edges is less than the capacity of an optical wavelength channel (e.g. 40 Gbps/100 Gbps). Since the actual traffic capacity of the wavelength channel is less, the remaining capacity is thereby unused while still consuming electric power in transmitting empty frames.

To address this issue, engagement of a multi-layer network control or network design to properly aggregate actual traffic into large capacity wavelength channels is conventionally required.

A second work involves reducing power consumption on switches themselves. In electrical switched devices, such as routers, ethernet switches, and optical transport network cross-connects (OTN-XC), power consumption can be reduced in network devices by miniaturization of complementary metal-oxide semiconductor (CMOS)-based chips. Also, in optical-switching devices, such as reconfigurable optical add/drop multiplexer (ROADM) and wavelength cross-connect (WXC), silicon photonics technologies contribute to reduced power consumption of optical switching devices.

A third work includes energy-aware routing, by determining which network nodes/ports should be turned off during off-peak traffic. By turning unused ports or nodes off, minimal energy use is possible during off-peak traffic demand. One difficulty of the energy-aware routing is how to monitor the sleeping nodes/ports and awaken with increased traffic flow.

The above works contribute significantly to reduce energy consumption in network systems or network devices. However, the majority of power consumption in wide area networks is in the cooling systems (e.g., air conditioner) in the network sites and data centers. The problem is over-cooling, in which the cooling systems are set to remove more heat capacity than actual heat energy generated from network devices. An example setup for a cooling system has a room target temperature set to 20° C., while the ambient operating temperature of the network devices is set between 0° C. to 45° C.

Network apparatuses (e.g., network devices and network servers) have different heat emission profiles (e.g., network routers generate more heat than WXC), and therefore the cooling systems need the capability to remove excessive heat generated from energy hungry network devices and network servers. Another reason is to respond to the heat energy emitted by temporal heavy traffic load. In order to protect thermal runaway of network devices or network servers from spotty heat energy or temporarily-generated heat energy (e.g., heat energy which is time-dependent), room temperatures are kept quite low with enough margin (e.g., over-cooling) to prevent problems.

In order to obtain significant energy savings while maintaining efficiency of network resources, and balanced control between energy-heat, network resources are required. There are conventional methods of dealing with energy-heat management and/or network (or server) resource allocations. However, such conventional technologies have drawbacks and failings.

### SUMMARY

In view of the foregoing and other exemplary problems, disadvantages, and drawbacks of the aforementioned conventional methods, an exemplary aspect of the present invention is directed to a control system and method of controlling a network which may reduce (e.g., minimize) total energy consumption in the network.

An exemplary aspect of the present invention is directed to a control system for controlling a network including a plurality of network apparatuses. The control system includes a network site controller for controlling a cooling system in the network and extracting network resource and ambient information from the plurality of network apparatuses into topological information, and a network controller for controlling the plurality of network apparatuses based on the topological information.

Another exemplary aspect of the present invention is directed to a network which includes a cooling system for removing heat energy generated by a plurality of network apparatuses, a network site controller for controlling the cooling system and extracting network resource and ambient information from the plurality of network apparatuses into topological information, a network controller which controls the plurality of network apparatuses based on the topological information.

Another exemplary aspect of the present invention is directed to a network apparatus which includes a cooling module which measures a first temperature of a coolant at a first position on the device, and a second temperature of the coolant at a second position on the device, and measures heat energy emitted from the device by comparing the first and second temperatures, and a monitoring module which collects statistical information on at least one of a flow of traffic in a network and a load on a server in the network.

Another exemplary aspect of the present invention is directed to a method of controlling a network. The method includes removing heat energy generated by a plurality of network apparatuses in a network, by using a cooling system, controlling the cooling system in the network and extracting network resource and ambient information from the plurality of network apparatuses into topological information, and controlling the plurality of network apparatuses based on the topological information.

Another exemplary aspect of the present invention is directed to a programmable storage medium tangibly embodying a program of machine-readable instructions executable by a digital processing apparatus to perform the method of controlling a network.

With its unique and novel features, the present invention may provide a control system and method of controlling a network which may reduce (e.g., minimize) total energy consumption in the network.

### BRIEF DESCRIPTION OF THE DRAWINGS

The foregoing and other exemplary purposes, aspects and advantages will be better understood from the following detailed description of the embodiments of the invention with reference to the drawings, in which:

FIG. 1 illustrates a control system 100 for controlling a network (e.g., a WAN) including a plurality of network apparatuses 130 according to an exemplary aspect of the present invention;

FIG. 2 illustrates a method 200 of controlling a network, according to an exemplary aspect of the present invention;

FIG. 3 illustrates a network 300 (e.g., a wide area network (WAN)), according to another exemplary aspect of the present invention;

FIG. 4 illustrates a network site 310, according to an exemplary aspect of the present invention;

FIG. 5 illustrates a generic configuration of a network device 131, according to an exemplary aspect of the present invention;

FIG. 6 illustrates a cooling module 530, according to an exemplary aspect of the present invention;

FIG. 7 illustrates a node management module 540, according to an exemplary aspect of the present invention;

FIG. 8 illustrates a network server rack 800, according to an exemplary aspect of the present invention;

FIG. 9 illustrates a server management module 830, according to an exemplary aspect of the present invention;

FIG. 10 illustrates a network site controller 110, according to an exemplary aspect of the present invention;

FIG. 11 illustrates a network controller 140 (e.g., WAN controller) for a network, according to an exemplary aspect of the present invention;

FIG. 12 illustrates a method 1200 (e.g., network abstraction method), according to an exemplary aspect of the present invention;

FIG. 13A illustrates a fixed heat profile (e.g., fixed temperature profile) for a network apparatus 130, according to an exemplary aspect of the present invention;

FIG. 13B illustrates a feedback heat profile (e.g., feedback temperature profile) for a network apparatus 130, according to an exemplary aspect of the present invention;

FIG. 14 illustrates a method 1400 of controlling a network (e.g., a path control method), according to an exemplary aspect of the present invention;

FIGS. 15A-15D illustrate examples of an intra-site route decision (e.g., route decision within one network site), according to an exemplary aspect of the present invention;

FIGS. 15E-15F illustrate an example of an inter-site route decision (e.g., route decision between two or more network sites), according to an exemplary aspect of the present invention;

FIG. 16 illustrates a method 1600 of controlling a cooling system (e.g., cooling system control method), according to another exemplary aspect of the present invention;

FIG. 17 illustrates a typical hardware configuration 1700 that may be used to implement the system and method of the present invention, in accordance with an exemplary aspect of the present invention; and

FIG. 18 illustrates a magnetic data storage diskette 1800 and compact disc (CD) 1802 that may be used to store instructions for performing the inventive method of the present invention, in accordance with an exemplary aspect of the present invention.

### DETAILED DESCRIPTION OF EXEMPLARY EMBODIMENTS OF THE INVENTION

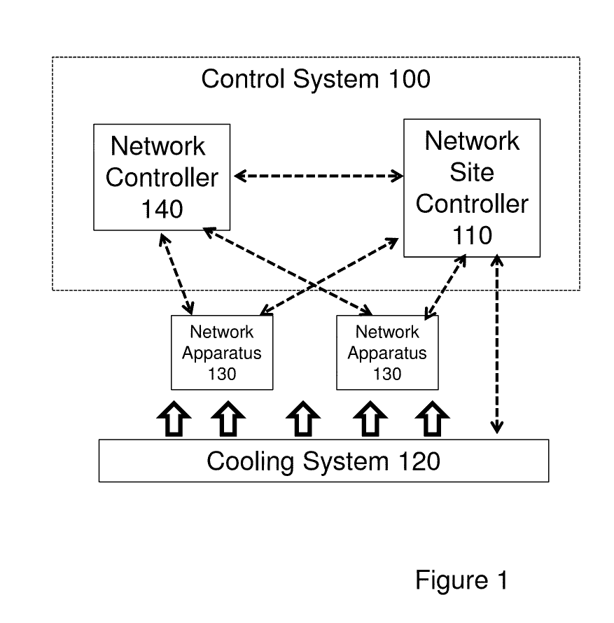

Referring now to the drawings, FIGS. 1-18 illustrate some of the exemplary aspects of the present invention.

Conventional technologies only focus on efficient resource allocations based on energy information gathered from networks or data centers. Thus, no conventional technologies pay attention to coordinated control between network/server systems and cooling systems by managing heat energy, in order to minimize energy consumption of cooling systems compliant with network devices or servers.

An exemplary aspect of the present invention relates to a heat-energy control system in a network (e.g., a WAN) using network devices/servers and methods of coordinated control in both the network and cooling system which cools a room which houses a network apparatus in the network. In particular, the control system may set and/or adjust a cooling system in the network site so that a temperature in a room at the network site can be set without over-cooling the room.

An innovation of the exemplary aspect of the present invention includes a coordinated control of the network and the cooling system through heat energy management. The coordinated control may use traffic volume information, temperature properties and ambient information around controlled objects to minimize energy consumption (e.g., total energy consumed by the network apparatuses and the cooling system) in the network.

FIG. 1 illustrates a control system 100 for controlling a network (e.g., a WAN) including a plurality of network apparatuses 130 according to an exemplary aspect of the present invention. The control system 100 may address the problems of the conventional technologies.

As illustrated in FIG. 1, the control system 100 includes a network site controller 110 for controlling a cooling system 120 in the network and extracting network resource and ambient information from the plurality of apparatuses 130 into topological information (e.g., mapping heat energy information to network status information), and a network controller 140 (e.g., WAN controller) for controlling the plurality of network apparatuses 130 (e.g., controlling a path and/or traffic flow among the plurality of network apparatuses 130) based on the topological information.

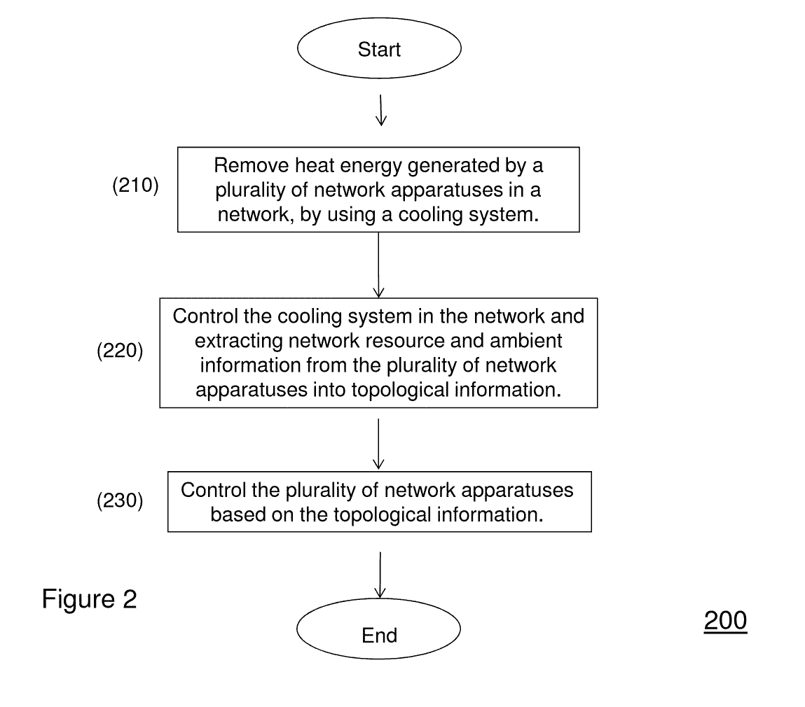

FIG. 2 illustrates a method 200 of controlling a network, according to an exemplary aspect of the present invention.

As illustrated in FIG. 2, the method 200 includes removing (210) heat energy generated by a plurality of network apparatuses in a network, by using a cooling system, controlling (220) the cooling system in the network and extracting network resource and ambient information from the plurality of network apparatuses into topological information, and controlling (230) the plurality of network apparatuses based on the topological information.

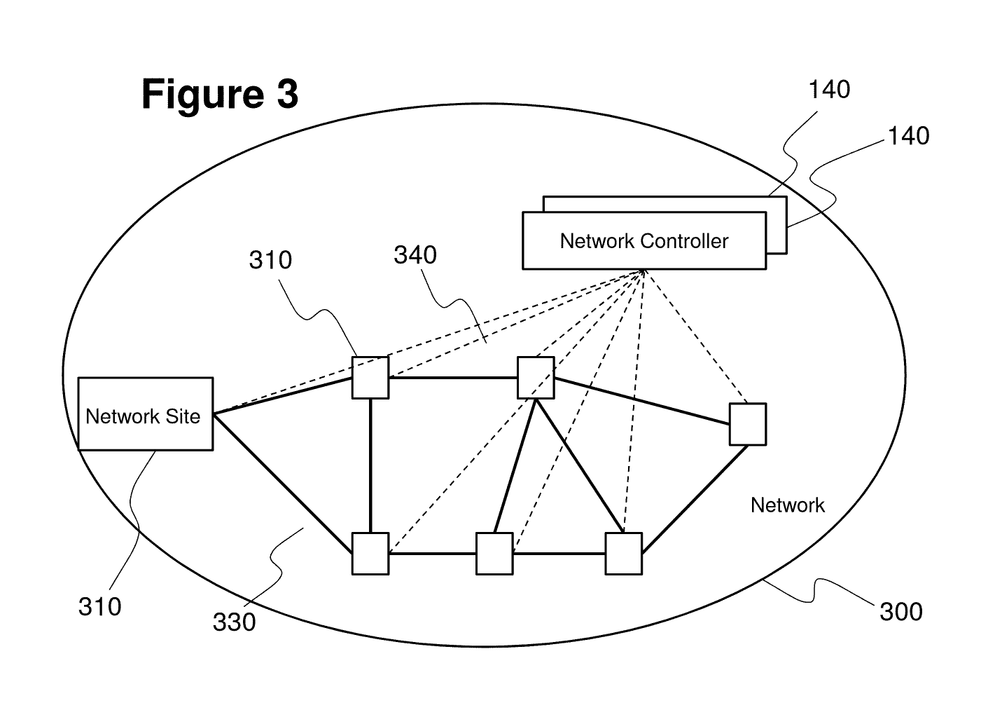

FIG. 3 illustrates a network 300 (e.g., a wide area network (WAN)), according to another exemplary aspect of the present invention.

The network 300 includes a plurality of network sites 310 co-locating a plurality of network apparatuses (e.g., various network devices and servers), and one or more network controllers (e.g., WAN controllers) 140 which may be placed, for example, in any of the network sites 310. The network sites 310 may be remotely located from each other (e.g., located on different building floors, different buildings, different cities, different states, etc.). The network sites 310 may be connected to each other, for example, by employing transmission lines 330 and control channels 340 via optical fiber and/or cables (e.g., copper cables). The network controllers 140 may be capable of monitoring the network apparatuses 130 in the network sites 310 via the control channels 30.

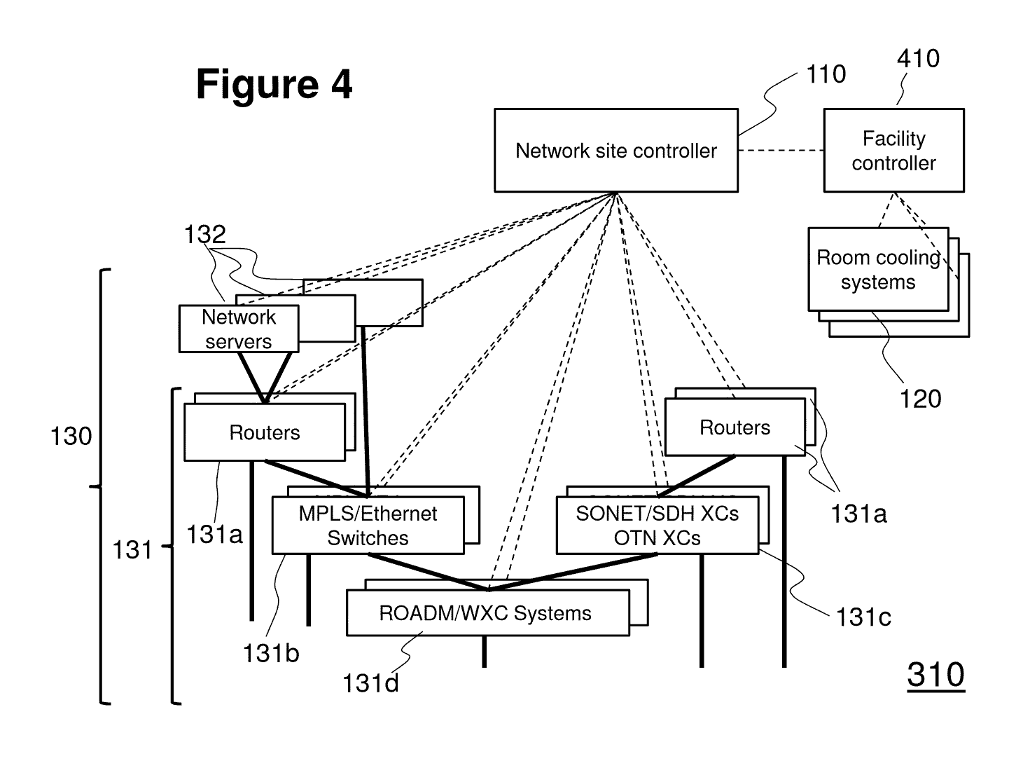

FIG. 4 illustrates a network site 310, according to an exemplary aspect of the present invention.

The network site 310 includes various types of network apparatuses 130 which may be interconnected via optical fiber or cables (e.g., copper cables). The network apparatuses 130 may include network devices 131 such as IP routers 131a, MPLS/Ethernet switches 131b, digital cross-connects 131c at granularities of SONET/SDH (Synchronous Optical NETwork/Synchronous Digital Hierarchy) frames or ODU (Optical Data Unit) frames, and ROADM/WXC (Reconfigurable Optical Add/Drop Multiplexer)/Wavelength cross-connect) systems 131d with WDM (Wavelength Division Multiplexing) transmission and optical switching capabilities.

The network apparatuses 130 may also include a network server 132 (e.g., plurality of network servers) which may be stored in one or more server racks at the network site 310. The network servers 132 may provide a control functionality for network services, such as VoIP (Voice over IP), video distribution and data communication.

The network site controllers 110 provide control functionalities for the network apparatuses 130 (e.g., network devices and network servers). The network apparatuses 130 may be housed in a room at a network site 310, and in order to maintain a temperature in the room, the network site 310 may include a facility controller 410 which controls a cooling system (e.g., room cooling system) 120 for the room at the network site 310.

The cooling system 120 may include a plurality of cooling systems 120 which are located in the same area or in different areas of the network site 310 (e.g., different locations in a room at the network site 310) for efficiently removing heat energy. The cooling system 120 may include, for example, a cooling unit as a heating, ventilation and cooling (HVAC) unit, air conditioner, chiller unit, or air exchange unit that is housed in the room with the network apparatuses 130, or is connected to the room by one or more ducts for transporting air (e.g., conditioned air, cooled air, etc.) from the cooling unit to the room. The cooling system 120 may also include one or more temperature sensors (e.g., thermometers) for measuring an ambient temperature in the room housing the network apparatuses 130.

In the exemplary aspect of FIG. 4, the network site controller 110 and facility controller 410 are located at the network site 310, but the network site controller 110 and/or the facility controller 410 could be co-located with the network controller 140 remotely from the network site 310 in a different implementation.

Further, the network 300 may be implemented as a wireless network in which the communication links in the network 300 (e.g., the communication links between the network controller 140 and the network apparatuses 130, between the network controller 140 and the network site controller 110, between the network site controller 110 and cooling system 120, between the network sites 310, and between the network apparatuses 130) include wireless communication links. In such an implementation, the features of the network 300 such as the network controller 140, network apparatuses 130, network site controller 110, cooling system 120 etc. may include wireless transmitter/receivers for wirelessly communicating on the wireless communication links.

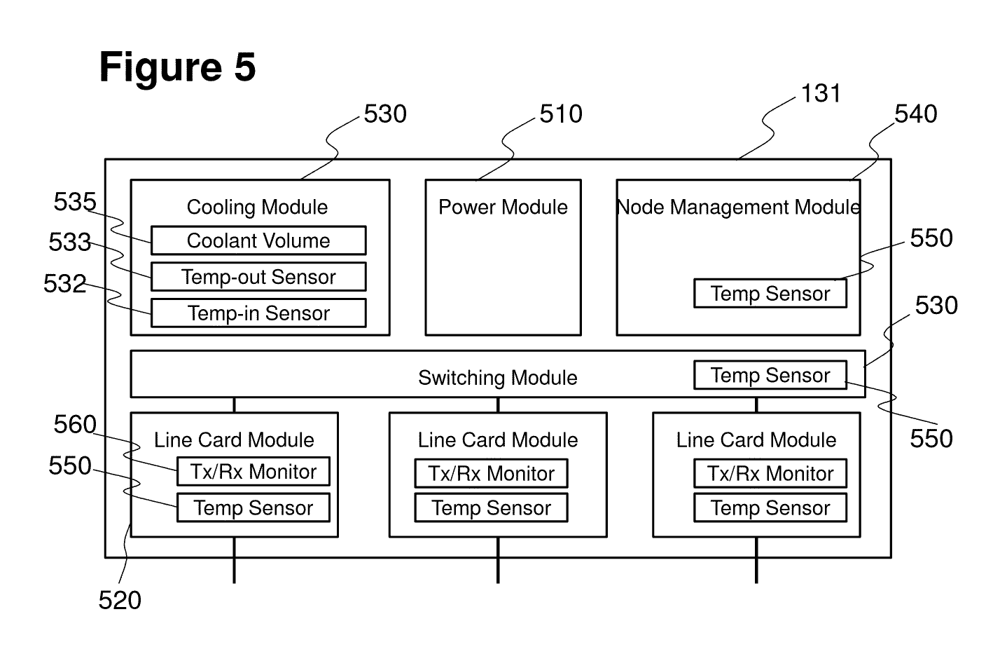

FIG. 5 illustrates a generic configuration of a network device 131, according to an exemplary aspect of the present invention.

The network device 131 includes a power module 510 to supply electric power to the device 131, a line card module (e.g., a plurality of line card modules) 520 with communication ports for allowing the device 131 to communicate with other devices, etc., a switching module 530 for switching traffic between line card modules 520, a cooling module 530 for removing heat energy generated from (e.g., cooling) the other modules in the device 131 (e.g., power module 510, line card module 520, etc.), and a node management module 540 for controlling the modules in the device 131.

The line card module 520, switching module 530, and the node management module 540 may include a temperature sensor 550 (e.g., infrared thermometer, thermistor, thermocouple, etc.) in order to measure a temperature of each module.

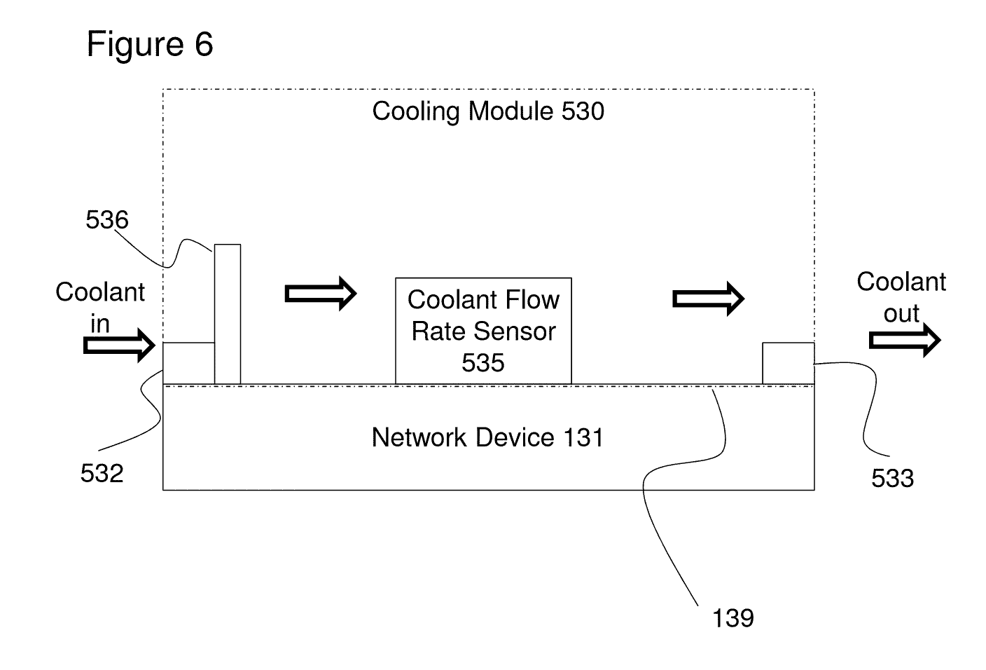

FIG. 6 illustrates a cooling module 530, according to an exemplary aspect of the present invention.

As illustrated in FIG. 6, the cooling module 530 may be formed on a surface of the network device 131. The cooling module 530 may include a plurality of temperature sensors, which may include a temperature-in sensor 532 for measuring the temperature of the coolant before heat energy is removed from the network device 131 (e.g., for measuring an ambient air temperature), and a temperature-out sensor 533 for measuring the temperature of the coolant after heat energy is removed from the network device 131.

As illustrated in FIG. 6, the cooling module 530 may also include a coolant flow rate sensor 535 (e.g., volumetric flow meter) for measuring a flow rate of a coolant (e.g., ambient air) used to cool the network device 131 for heat energy removal. The cooling module 530 may also include a cooling fan 536 for forcing a flow of the coolant (e.g., ambient air) over a surface of the network device 131. The cooling fan 536 may be, for example, a variable speed fan so that a speed of the cooling fan 536 may be adjusted (e.g., automatically adjusted) in order to vary the volumetric flow rate of coolant.

For example, the temperature-in sensor 532 may be formed on a surface 139 of the network device 131 at a first end (e.g., edge) of the network device 131, and the temperature-out sensor 533 may be formed on the surface 139 at a second end of the network device 131 which is opposite the first end. The cooling fan 536 forces ambient air (e.g., coolant) over the surface 139 so that heat energy is transferred from the surface 139 to the ambient air.

It should be noted that the cooling module 530 may include (e.g., instead of a coolant flow rate sensor 305) a processor for estimating a coolant flow rate based on one or more variables such as a speed of the cooling fan 536, the ambient temperature, etc. In addition, the cooling module 530 may be formed as a single unit, or in parts which are remotely located on the network device 131, but in communication by a communication link (e.g., wired or wireless communication link).

Further, although the cooling module 530 is illustrated in FIG. 6 as being formed on a network device 131, the cooling module 530 may also be formed on a network server 132 with a similar configuration in order to cool the network server 132.

Referring again to FIG. 5, the node management module 540 may collect the information obtained from the temperature-in sensor 532, the temperature-out sensor 533, and the coolant flow rate sensor 305, and use the information to calculates total heat energy per unit time (e.g., per second) emitted from the device (e.g., heat energy removed by the coolant) by following the equation,

Q[J/K]=C*(T2−T1)*V Eq. (1),

where, Q is total heat energy per unit time emitted from the device (e.g., heat energy removed by the coolant), C is heat capacity of the coolant, T1 is the coolant-in temperature (e.g., temperature at the temperature-in sensor 532), T2 is the coolant-out temperature (e.g., temperature at the temperature-out sensor 533), and V indicates a volumetric flow rate of coolant (e.g., volume of coolant flowed over a surface of the network device 131 per unit time).

In addition, the line card module 520 may include a Tx/Rx monitor 560 for measuring traffic statistics on the ports of the network device 131 including, but not limited to, the number of packets sent/received by the network device 131, the number of bytes sent/received by the network device 131, and the number of error packets sent/received by the network device 131. The Tx/Rx monitor 560 may also include the ability to measure flow-based traffic statistics which matches specific values in the packet header fields (i.e. source/destination MAC address, VLAN ID, protocol number, source/destination IP address, TCP/UDP port and etc.).

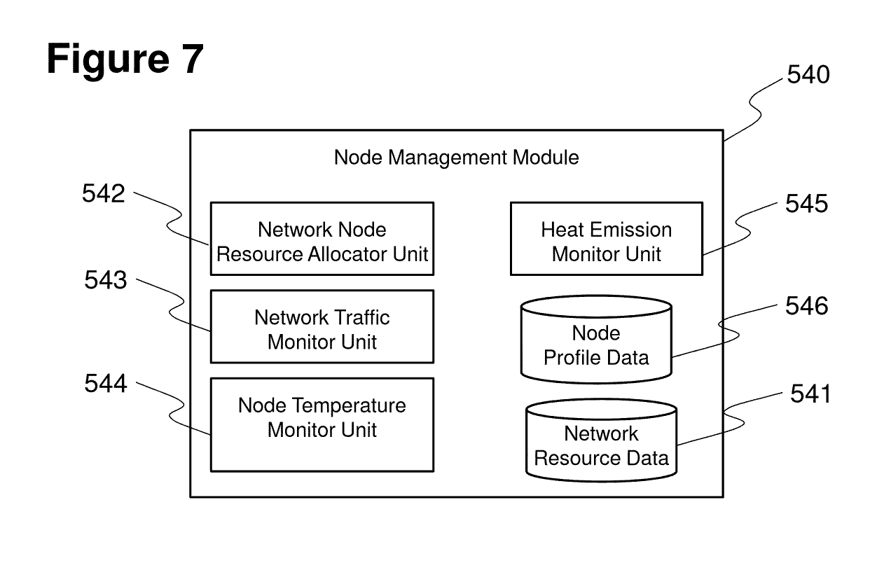

FIG. 7 illustrates a node management module 540, according to an exemplary aspect of the present invention.

The node management module 540 includes network status data 541 (e.g., memory for storing the data), and a network node resource allocator unit 542 that assigns network resources on the network device 131 based on the current resource availability stored in the network status data 541. A resource allocation request may be transmitted from the network controller 140 directly to the network device 131, or indirectly via the network site controller 110. One exception of autonomous resource allocation on network devices is failure recovery based on local decision, which is invoked by detection of failure events on a network device 131.

The network traffic monitor unit 543 manages statistical traffic information gathered by the Tx/Rx monitor on the line cards, and the node temperature monitor unit 544 manages module temperature information gathered by the temperature sensors 532, 533, 550 on the network device 131. The heat emission monitor unit 545 calculates heat energy emitted from network devices 131, for example, by using Equation (1).

The statistical traffic information and calculated heat energy emitted (e.g., heat energy removed) from the network devices 131 are stored in the node profile data 546 (e.g., memory for storing the data) in one or more pre-configured time intervals (e.g., seconds, minutes, hours, days, month, year. etc.).

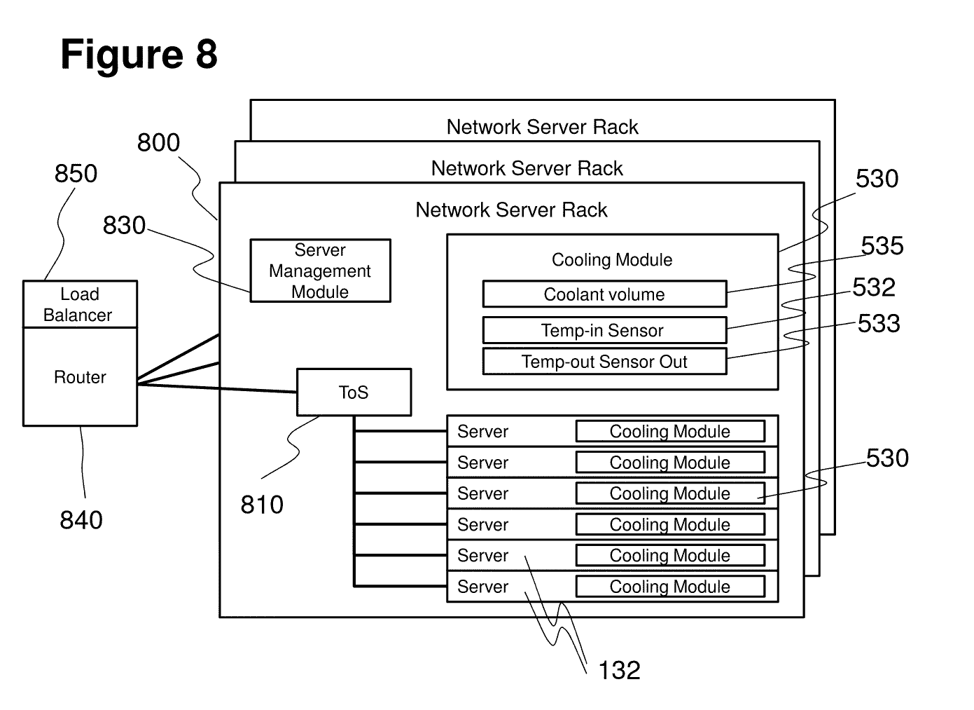

FIG. 8 illustrates a network server rack 800 (e.g., plurality of network server racks 800), according to an exemplary aspect of the present invention.

As illustrated in FIG. 8, the network server rack 800 may include a plurality of network servers 132 (e.g., computing servers), a top-of-rack switch (TOS) 810 for aggregating/distributing traffic from/to the network servers 132, a cooling module 530 (e.g., rack cooling module) which may have the same configuration as that of the cooling module 530 illustrated in FIG. 6, and a server management module 830. The TOS 810 is interconnected via the router 131a, which may have a traffic load balancer 850 for balancing traffic load among the network servers 132.

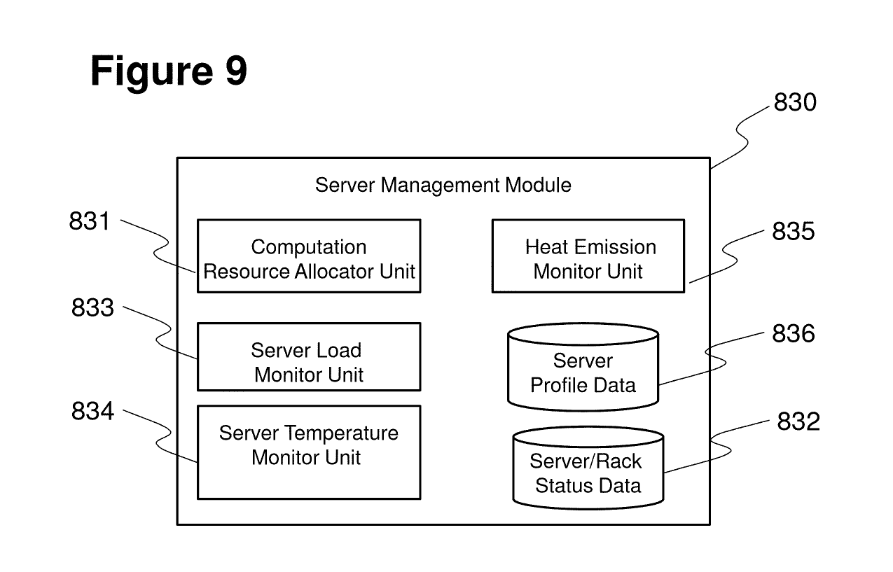

FIG. 9 illustrates a server management module 830, according to an exemplary aspect of the present invention.

As illustrated in FIG. 9, the server management module 830 may include server/rack status data 832, and a computation resource allocator unit 831 that allocates (e.g., assigns) available network servers 132, and/or computation resources in the server 132 such as a central processing unit (CPU), memory, and input/output devices (I/O), within a rack 800 or across multiple racks 800 using current computation resource availability stored in the server/rack status data 832. The computation resource allocator unit 831 may allocate the network servers 132 in response to a computation resource allocation request which may be transmitted from the network controller 140 to the network server 132 either directly or via the network site controller 110. One exception of autonomous resource allocation is failure recovery based on local decision, invoked by detection of failure events on a server 132.

The server management module 830 may also include a server load monitor unit 833 that manages usage of the computation resources, a server temperature monitor unit 834 that manages the temperature information gathered by the temperature sensors 532, 533 on the network servers 132, and a heat emission monitor unit 835 that calculates heat energy emitted from a rack 800 and/or one or more network servers 132, for example, by using Equation (1).

The server management module 830 may also include server profile data 836. The computation resource usage information and the calculated heat energy from the servers 132 may be stored in the server profile data 836 in one or more pre-configured time intervals (seconds, minutes, hours, days, month, year. etc.).

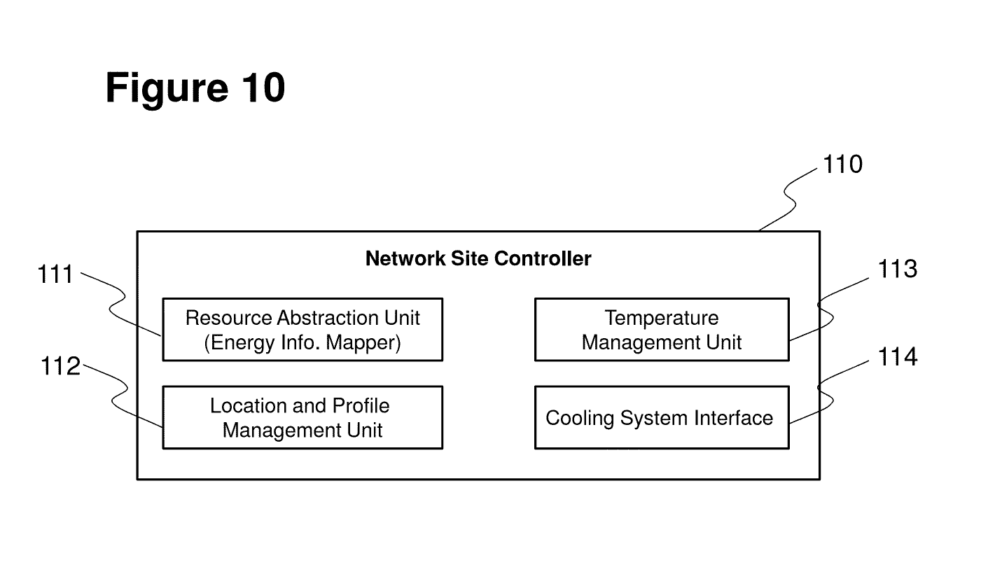

FIG. 10 illustrates a network site controller 110, according to an exemplary aspect of the present invention.

The network site controller 110 may control the network apparatuses 130 (e.g., network devices 131 and network servers 132) and the cooling system 120. The network site controller 110 may include a resource abstraction unit 111 for mapping heat energy information to network status information. For example, for a server 132, the resource abstraction unit 111 may generate a list which identifies a value of heat energy emitted by the server 132 and a processing rate (bytes per second) for the server 132 which corresponds to that value of heat energy.

The network site controller 110 may also include a location and profile management unit 112 which manages a location and a profile of network devices 131 and network servers 132 in the network site 310, a temperature management unit 113 which collects temperature information from network devices 131 and network servers 132, and a cooling system interface 114 for adjusting target temperatures of the cooling system 120 via the facility controller 410. The room temperature, at different locations, may correspond with a temperature detected by the temperature-in sensor 532 (ambient temperature) which is associated with one or more network device 131, a network server 132, or rack 800 in the room.

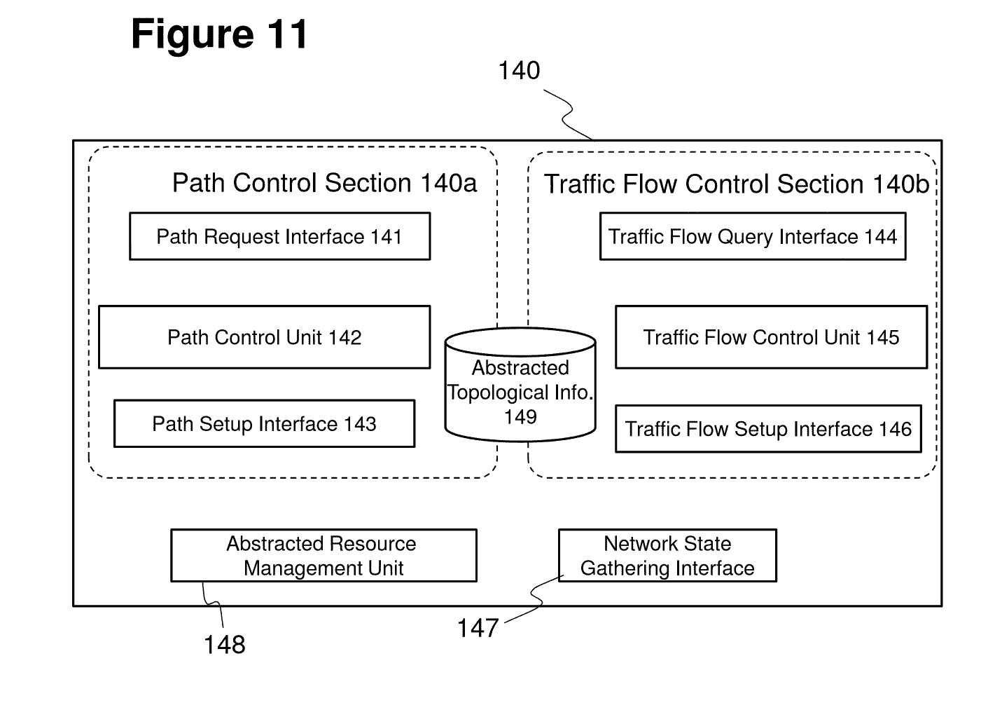

FIG. 11 illustrates a network controller 140 (e.g., WAN controller) for a network, according to an exemplary aspect of the present invention.

As illustrated in FIG. 11, the network controller 140 may include a plurality of sections for performing a plurality of network control capabilities. In particular, the network controller 140 may include a path control section 140a for providing a path control capability, and a traffic flow control section 140b for providing a traffic flow control capability.

For example, the path control capability may include setup, deletion, modification and failure recovery for physical/logical bandwidth manageable connections (i.e. MPLS LSPs (Label Switched Paths), SONET/SDH or OTN paths, and wavelength paths), and the traffic flow control capability may include switching, filtering and shaping for the packet stream, such as TCP/UDP, IP and Ethernet, at network edges or grooming points within the network 300.

The path control section 140a may include a path request interface 141 to receive new service requests (e.g., path setup query) from one or more users or network operators, a path control unit 142 with path computation functionality on given network topologies, and a path setup interface 143 to setup paths on network apparatuses 130.

The traffic flow control section 140b may include a traffic flow query interface 144 which sends or receives routing information for traffic flow via existing routing protocols such as; BGP, OSPF, RIP, or OpenFlow protocol, a traffic flow control unit 145 for controlling packet forwarding based on routing information, and a traffic flow setup interface 146 to setup flow forwarding information on network apparatuses.

The network controller 140 may also include a network state gathering interface 147, and an abstract resource management unit 148 which maintains network status information, room temperature information and heat emission information of network devices 131 and network servers 132, all of which are gathered via the network state gathering interface 147. The network controller 140 may also include a data storage device (e.g., RAM) 149, which is accessible by the path control section 140a and traffic flow control section 140b, and stores the abstracted topological information from the network apparatuses 130.

The exemplary aspects of the present invention may include a plurality of methods of controlling the network 300. The methods may include, for example, a network abstraction method, a path control method and a traffic flow control method.

It should be noted that the terms “resource” and “network apparatus” are used interchangeably herein, and as used herein both terms should be construed to include (e.g., but not limited to) a network device 131, a computing device (e.g., computer) in the network 300, a network server 132 in the network, a rack 800 of network servers 132 (e.g., a plurality of servers) in the network 300, etc.

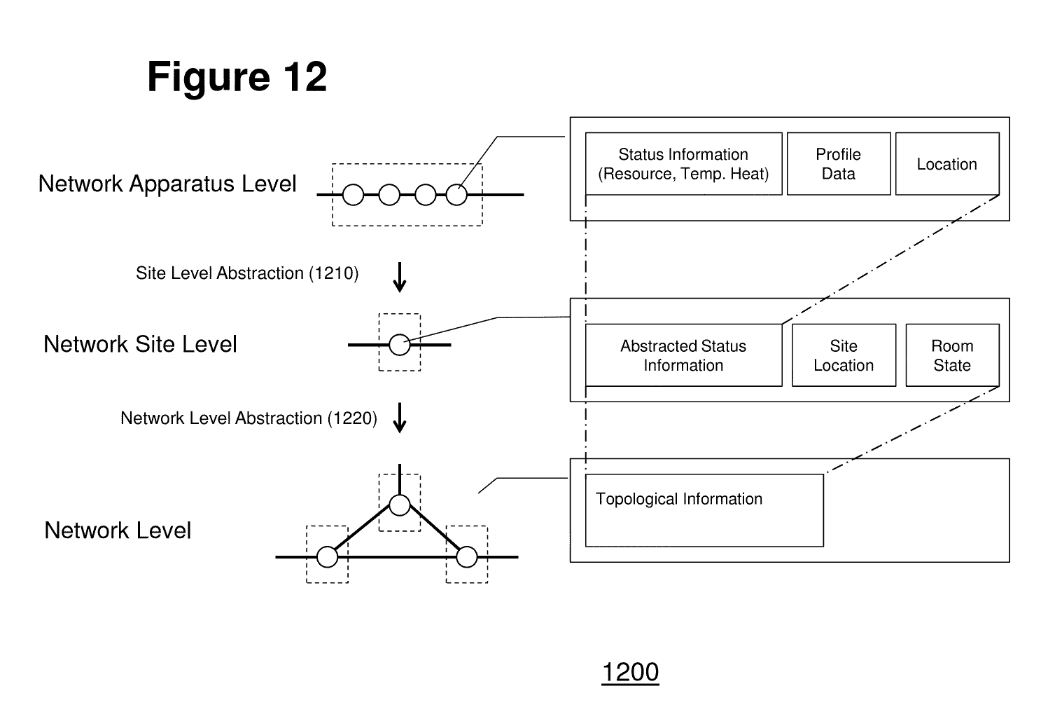

FIG. 12 illustrates a method 1200 (e.g., network abstraction method), according to an exemplary aspect of the present invention.

The method 1200 may include an information abstraction of network resources, a temperature at a network apparatus 130 (e.g. network device 131, network server 132), or a room temperature (e.g., ambient temperature), heat emission from a network apparatus 130, individual profile (e.g., temperature profile) of a network apparatus 130, and a location of a network apparatus 130 in a topological map.

More particularly, the method 1200 may follow a flow chart for abstraction as illustrated in FIG. 12. In particular, the method 1200 may use at a network apparatus level, status information, profile data and location data for a network apparatus 130 in a network site 310. The method 1200 may include, at the network site level, abstracting (1210) information of the plurality of network apparatuses 130 into a single node and links with each network layer (i.e. servers, IP, MPLS, and WDM) in the network 300. The network site level information may combine a topological network within the network 300. The method 1200 may also include, through this abstraction process, abstracting (1220) the network information into topological information for the network 300.

Example attributes of such topological information may include node attributes and link attributes, which include but are not limited to:

Node attributes:
Identifiers; node ID, site ID,
Cost: node cost (any type of numeric value)
Heat info; room temperature, heat energy emitted
Resources available for drop off and transit
Protection matrix (track protection resources needed)
Intra-site node representing individual node profile and temperature
Intra-site links represent the node
Total maximum heat absorption capacity for node

Link attributes:
Identifiers: link ID, and site ID,
Cost: link cost (any type of numeric value)
Connectivity: network layer, edge endpoints, lower_layer_path
Flags: use_for_working; use_for_protection
Capacity assigned: working, protection
Resources available: for working, for protection
Resources available without asking more resources to lower layer
Protection matrix (track protection resources needed)
QoS attributes: length, delay, num_hops
Maximum allowable working capacity
Maximum heat absorption capacity for link

In the node attribute, “total acceptable heat absorption capacity” may include total traffic or load acceptable on a corresponding network node (e.g., network apparatus 130, network server rack 800, etc.) without impacting the heat limit of the network node, and “maximum heat absorption capacity”, in the link attribute, may offer link capacity without impacting the heat limit of the network node.

A heat absorption capacity for a network apparatus 130 may be calculated using a heat (e.g., temperature) profile of the network apparatus 130. The heat absorption capacity may be calculated, for example, by the node management module 540 or the server management module 830.

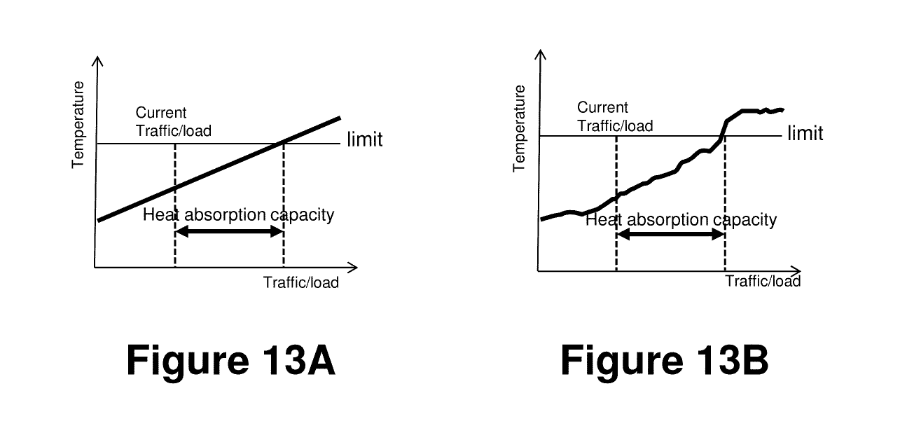

FIG. 13A illustrates a fixed heat profile (e.g., fixed temperature profile) for a network apparatus 130, according to an exemplary aspect of the present invention.

In particular, the fixed heat profile is illustrated by a graph which plots temperature vs. traffic/load in the network apparatus 130. The fixed heat profile may be an intrinsic representative of the network apparatus 130. The heat absorption capacity (e.g., maximum heat absorption capacity) may be defined as the difference (e.g., delta) between a current traffic/load and the traffic/load at the limit temperature.

A heat profile of a network apparatus 130 (e.g., network device, network server) or a rack of network servers, etc.) may be used for a node attribute, and similarly, a heat profile for a line card module 520 may be used for a link attribute. Thus, for example, in assigning (e.g., allocating) a resource, the network node resource allocator unit 542 and the computation resource allocator unit 831 would reject a bandwidth or computation request which exceeds the heat absorption capacity which is illustrated in FIG. 13A.

FIG. 13B illustrates a feedback heat profile (e.g., feedback temperature profile) for a network apparatus 130, according to an exemplary aspect of the present invention.

Similar to the fixed heat profile in FIG. 13A, the feedback heat profile is illustrated by a graph which plots temperature vs. traffic/load in the network apparatus 130, and the heat absorption capacity (e.g., maximum heat absorption capacity) may be defined as the difference (e.g., delta) between a current traffic/load and the traffic/load at the limit temperature.

However, the feedback heat profile in FIG. 13B may be generated by using a feedback mechanism. For example, the feedback heat profile can be updated periodically with actual temperatures and traffic/load information. The feedback heat profile in FIG. 13B may provide a more precise estimation of heat absorption capacity for the network apparatus 130.

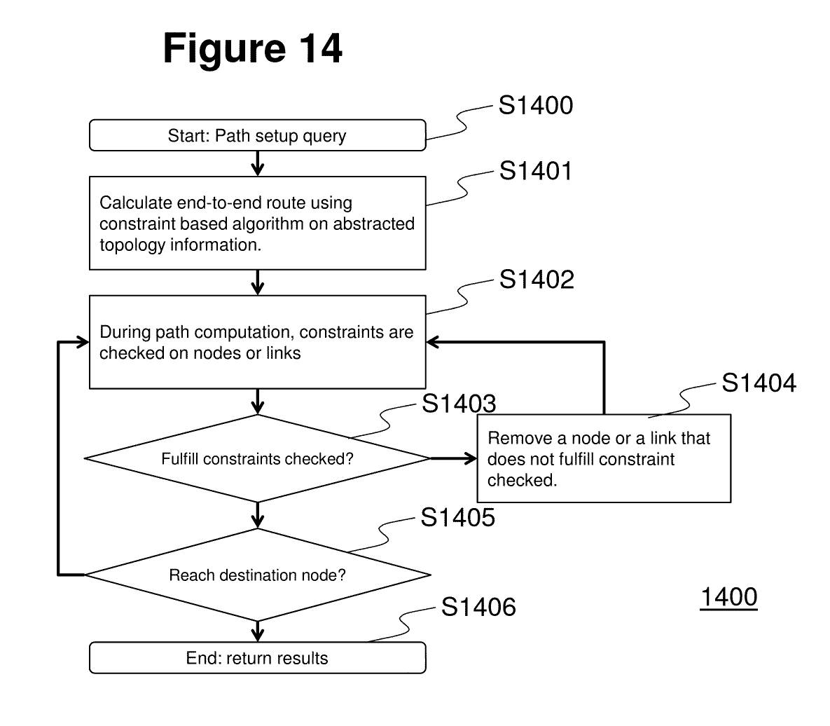

FIG. 14 illustrates a method 1400 of controlling a network (e.g., a path control method), according to an exemplary aspect of the present invention. In particular, the method 1400 may illustrate an operation of a path control section 140a in the network controller 140.

The method 1400 may include path setup, deletion, modification and failure recovery for physical/logical bandwidth manageable connections, taking care of heat energy emitted from the network apparatus 130.

As illustrated in the flow chart of FIG. 14, at (S1400) the path control unit 142 in the network controller 140 receives a path setup query which includes constraint information (bandwidth, protection type, routing policy, etc.) via the path request interface 143 (S1400). At (S1401) the path control unit 142 initiates a path computation for the end-to-end route, using a constraint-based path computation algorithm. The path control unit 142 may include, for example, a memory device (e.g., RAM, ROM, etc.) for storing the path computation algorithm, and a processor (e.g., microprocessor) which accesses the path computation algorithm to perform the path computation.

In (S1402, S1403), during the path computation in the node/link attributes, the path control unit 142 performs the algorithm to check the constraints on available resources and heat absorption capacity. If the constraints are not fulfilled on a node or link, then at (S1404) the path control unit 142 removes that node or link from a list of candidate routes (e.g., candidate paths), and continues the path computation.

After the path computation results are obtained from the source to destination nodes, the path control unit 142 returns the results to the entity (e.g., user, network operator, etc.) which transmitted the path setup request to the network controller 140 (S1431, S1406). If there is no route due to heat absorption capacity constraints, then the path control unit 142 can decrease or ignore the constraints on corresponding nodes or links. This would result in a temperature increase around the corresponding node. However, this issue can be resolved by properly controlling the cooling system 120.

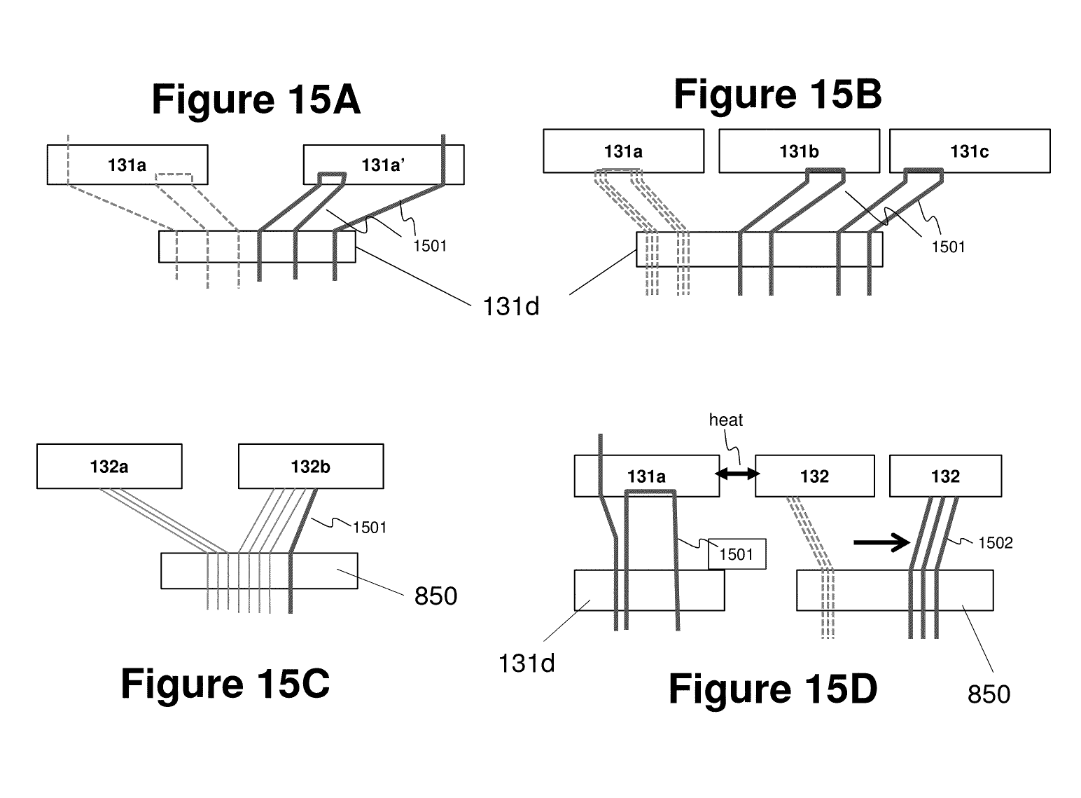

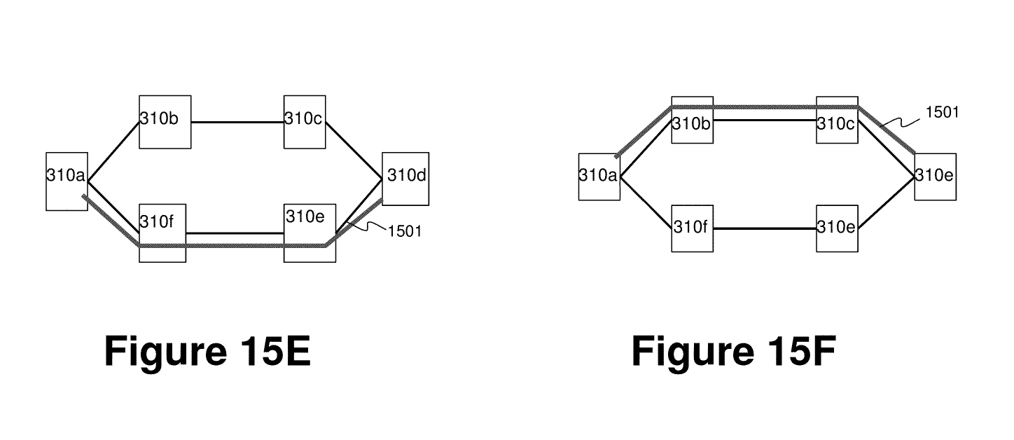

FIGS. 15A-15D illustrate examples of an intra-site route decision (e.g., route decision within one network site), according to an exemplary aspect of the present invention, and FIGS. 15E-15F illustrate an example of an inter-site route decision (e.g., route decision between two or more network sites), according to an exemplary aspect of the present invention. In particular, FIG. 15A illustrates a redundant network device selection, FIG. 15B illustrates a traffic off-load to lower layer, FIG. 15C illustrates a network server load balance, FIG. 15D illustrates mixed heat control between neighbors, FIG. 15E illustrates end-to-end heat optimization and FIG. 15F illustrates delta-temperature route selection.

During the path computation, intra-site and inter-site route decisions may be made using constraints, including heat absorption capacity, in order to avoid generating hot spots within the site or hot sites in the network 300. FIGS. 15A-15F illustrate some of standard route decisions in the path control method (e.g., method 1400).

FIG. 15A illustrates a route decision example to select a network device located in a lower heat area in a site containing two or more network devices for the purpose of redundancy or load balancing. In particular, in this example, the router 131a includes a heated area, the router 131a′ includes a stable heat area (e.g., the temperature of the router 131a′ is not increasing), so that the selected route 1501 for traffic flow is via the WDM system 131d (e.g., ROADM/W×C system 131d with WDM transmission and optical switching capability) to the router 131b.

FIG. 15B illustrates a route decision example for traffic off-load from a higher network layer to a lower layer(s), where heat emission is less at the lower layer(s). In this example, the path control unit can determine routes by comparing capacity efficiency with heat emission efficiency. In particular, in this example, the router 131a includes a heated area, the MPLS/Ether switch 131b includes a stable heat area and the OTN XC 131 includes a stable heat area, so that the selected route 1501 for traffic flow is via the WDM system 131d to the MPLS/ether switch 131b and the OTN XC 131c.

FIG. 15C illustrates an example of using a load balancer 850 to select a network server based on the amount of heat emission from servers or racks. In particular, in this example, the network server 132a (e.g., or network server rack 800) includes a high heat emission (e.g., as determined by Equation (1) above), and the network server 132b includes a low heat emission, so that the selected route 1501 for traffic flow is via the load balancer 850 to the network server 132b

FIG. 15D illustrates an example of a heat mixture control between neighbor locations. In this example, it is assumed that new traffic flow will use a router 131 having a heat emission 1590 that will increase the temperature of the network server 132a located next to the router 131. In order to avoid negative heat effect from the router 131 (e.g., a router which “neighbors” the server 132a), the route for traffic flow may be changed from the server 132a to the server 132b which is a stable heat area, via the load balancer 850.

FIG. 15E illustrates a geographical load balancing example in the network 300, in which route decision for end-to-end paths is made based on the total amount of heat emission in the network sites 310a-310f. In particular, in this example, the network 300 includes network site 310a, network site 310b (heated site), network site 310c (stable heat site), network site 310d, network site 310e (stable heat site) and network site 310f (stable heat site), so that the selected route 1501 between network sites 310a and 310d, is via network sites 310f and 310e.

FIG. 15F illustrates an example of environment-sensitive route selection. A route decision is made using the delta-temperature between room and ambient temperature in a geographical area (outside temperature). The power efficiency of a cooling system 120 (e.g., room cooling system) increases as the delta-temperature between an outside temperature (e.g., a temperature of the ambient air outside the target room which houses the network apparatuses 130 at the network site 310) and an inside temperature (e.g., a temperature of the ambient air inside the room) decreases, assuming that the inside temperature is less than the outside temperature. Therefore, by choosing the route with the maximum sum of delta-temperature, the total energy consumption in the cooling system 120 can be minimized in the network 300.

In particular, in this example, the network 300 includes network site 310a, network site 310b (large delta-temperature), network site 310c (large delta-temperature), network site 310d, network site 310e (small delta-temperature) and network site 310f (small delta-temperature), so that the selected route 1501 between network sites 310a and 310d, is via network sites 310b and 310c.

The path control methods illustrated in FIGS. 15A-15F can be applied to both new path setup and existing path modification (e.g., re-configuration of a path).

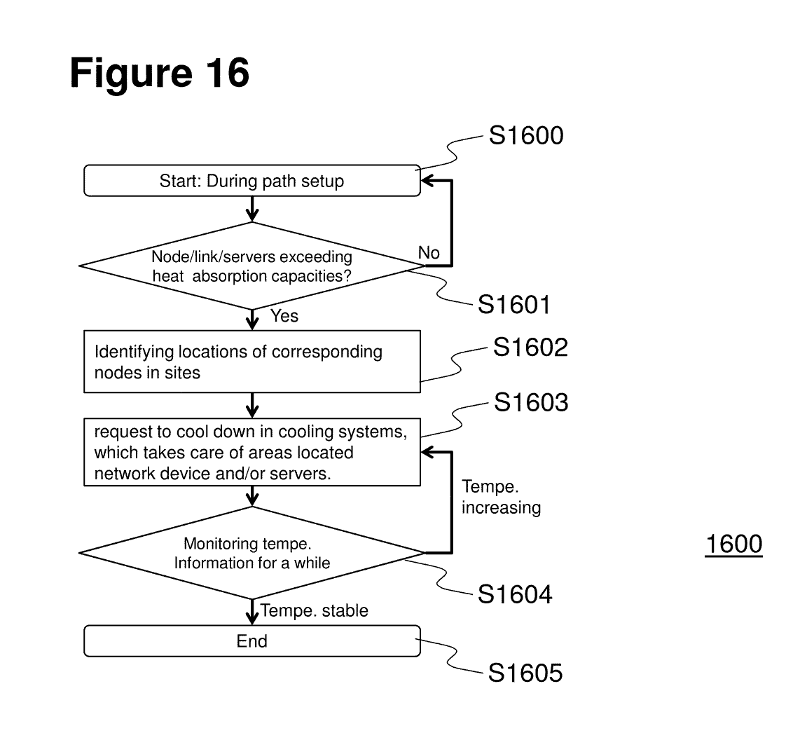

FIG. 16 illustrates a method 1600 of controlling a cooling system (e.g., cooling system control method), according to another exemplary aspect of the present invention.

The method 1600 may include a coordinated control between path setup and a cooling system (e.g., plural cooling systems) in intra-site (e.g., within a network site 310) or inter-sites (e.g., between two or more network sites 310), through the micro-management of heat emission.

The method 1600 (e.g., first coordinated control method) may include a spot cooling system control within a network site 310. As described in the method 1400 (e.g., path control method) if there are no heat absorption capacity constraints, the path computation unit can decrease or ignore the constraints on nodes or links, which may result in a temperature increase around corresponding nodes. In this case, removal of heat energy around the corresponding nodes is required in order to avoid thermal runaway or hardware damage.

A detailed procedure for method 1600 may be more clearly understood by referring to FIGS. 1, 2 and 7. During path control, the network controller 140 determines whether there are any nodes, links and/or servers that have exceeded the heat absorption capacities (S1600, S1601). If there are none, then the process returns to path setup (S1600), but if there are nodes, links and/or servers that have exceeded the heat absorption capacities, then in each network site controller 110, the location and profile management unit 112 identifies the location of the apparatus 130 corresponding to the nodes, links, and/or servers on its topology (i.e., the apparatus which is exceeding its heat absorption capacity (S1602).

The temperature management unit 113 then requests the facility controller 410, via the cooling system interface 114, to cool down the corresponding areas where the apparatus 130 is located. On receipt of this request, the facility controller 410 selects the cooling system 120 for the corresponding area, and changes the settings of the cooling system 120 (S1603).

After changing the setting, the temperature management unit 113 continues to monitor temperature information gathered from the apparatus 130 for at least 5 seconds or more preferably at least about 10 seconds). If the temperature continues to increase, the temperature management unit sends a request to change the settings of the cooling system 120 until the temperature on then network apparatus 130 becomes stable (e.g., until the temperature remains the same for at least 5 seconds or more preferably at least about 10 seconds) (S1604, S1605).

The temperature management unit 113, in the network site controller 110, periodically checks whether the total heat energy emission from the network apparatus 130 exceeds the heat removal capacity of the cooling system 120 (e.g., the cooling system 120 in the room which houses the network apparatus 130 which is exceeding its heat absorption capacity). If the total heat energy emission is more than the heat removing capacity, the temperature management unit 113 requests the facility controller 410 to change the cooling system 120 setting to ensure the proper heat removing capacity.

The second coordinated control method includes a delta-temperature router selection for inter-sites, as illustrated in FIG. 12F. As described above, the power efficiency of a cooling system 120 increases as the delta-temperature between an outside temperature and an inside temperature decreases, assuming that the inside temperature is less than the outside temperature. Therefore, by choosing the route (e.g., a route between a source network site 310 and a destination network site 310) with the maximum sum of delta-temperatures, total energy consumption of the cooling systems 120 in the can be minimized in the network 300.

In the network site controller 110, the temperature management unit 113 has the capability of measuring outside temperature and calculating the delta-temperature. The delta-temperature can be used for either a node cost in the node attribute or a link cost in the link attribute, so that the path control unit in the network controller 140 can calculate the most energy efficient route between a source site to a destination site, in terms of power consumption in cooling systems.

An exemplary aspect of the present invention may further support a traffic flow control method in the network 300. Traffic flow control may be defined as a flow-by-flow control of packet traffic streams over established paths (controlled by the path control method). Examples of traffic flow control include load balancing of traffic flow over multiple paths, priority queuing control in buffer memories, packet filtering for security, and traffic policing and shaping for QoS maintenance.

Traffic flow control in the network 300 may be accomplished by using the traffic flow control modules 144, 145, 146 of the traffic flow control section 140b in the network controller 140 in FIG. 11. The traffic flow control method provides a truer heat energy emission control, since heat emission from a network apparatus 130 is proportional to traffic volume on the network apparatus 130 (e.g., heat emission increases with an increase in traffic volume). Therefore, the traffic flow control in conjunction with traffic or load monitoring helps to coordinate appropriate heat emission of the network apparatuses 130 and cooling systems 120 in the network 300.

Total energy consumption in the network apparatuses 130 and cooling systems 120 can be reduced significantly, because the coordinated control of network apparatuses 130 and cooling systems 120 allows an operator of the network 300 to set the cooling systems 120 with quite less margin.

An exemplary aspect of the present invention also provides an automatic network control method for network operators, which eliminates workload for complicated network and server configurations, and thus may help to reduce network failure caused by human errors.

It should be noted that the controllers described herein (e.g., network controller 140, network site controller 110), and the monitors, monitor units and resource allocator units (e.g., Tx/Rx Monitor 560, network node resource allocator unit 542, network traffic monitor unit 543) described herein may be implemented by using a processor (e.g., microprocessor), and the data (e.g., node profile data 546) may be implemented using a memory device (e.g., random access memory (RAM), magnetic memory device).

In summary, an exemplary aspect of the present invention is directed to a network system (e.g., WAN system) including numerous network sites containing various type of apparatus that are interconnected by optical fiber or copper cables, a number of optical transmission lines for connecting the network sites, a variety of room cooling systems for removing heat energy generated by the network apparatus from the network site, one or more network site controllers for abstracting apparatus state and ambient information into topological information and for controlling the room cooling systems in the network site, one or more network controllers for monitoring bandwidth manageable paths within or among each of the network sites.

The network controller may regulate paths by allocating network and/or computation (e.g., computer) resources based on the available resource and ambient condition constraints of the apparatus using the abstracted topological information from the network site controller.

The network apparatuses may include a heat energy management capability to measure heat energy emitted from the apparatus, and a heat emission profile of the apparatus to calculate heat absorption capacity indicating acceptable bandwidth or computation load. The apparatuses may include a capability to compute the volume of heat emission by using two temperature sensors to measure temperature before and after removing heat energy generated from the apparatuses.

Another exemplary aspect of the present invention is directed to a network apparatus. The network apparatus may include a cooling module having the capability to measure heat energy emitted from the apparatus by comparing coolant temperatures before and after removing heat energy, and a monitoring module which collects statistical information on network traffic or server load. The network apparatus may store temperature profile information, and include the capability to calculate heat absorption capacity using current ambient conditions acceptable for traffic or load.

The network controller may regulate paths by allocating network and/or computation resources based on available resource and heat absorption capacity constraints of the apparatus using the topological information from the network site controller. If the network site controller detects that the total heat energy emitted from the apparatus is exceeding the heat removing capacity of the cooling system, then the site controller may change the cooling system setting to enhance the heat removing capability in the cooling system.

If the network controller fails to find a route for a path, due to heat absorption capacity constraints, then the network controller may decrease or ignore the constraints to setup the a path along a possible router, and then change the cooling system setting managing areas locating the corresponding apparatus. If two or more apparatuses are located in a network site, the network controller may allocate network and/or computer resources by regulating heat emissions from a neighboring apparatus.

The network controller may use heat absorption capacity in node/link attributes as path computation cost, by allocating resources along the paths with the maximum sum of heat absorption capability. The network site controller may compute a delta-temperature between outside and room temperature, and the network controller may use the delta-temperature as a path computation cost and allocate resources along the path with a maximum sum of delta-temperature.

Another exemplary aspect of the present invention is directed to a control system for a network. The control system may include a set of network site controller for controlling apparatuses and cooling systems in the network site. The network site controller may include a resource abstraction unit for selecting network resources and ambient information into topological information, a location and profile management unit for storing locations and profiles of apparatuses in the network site, a temperature management unit for monitoring apparatus and, room temperature, and a cooling system interface to request setting changes to cooling systems in the network site.

In addition to the network site controller, the control system may also include a network controller. The network controller may include a path control section and/or a traffic flow control section.

The path control section may control bandwidth manageable connections in the network. The path control section may include a path request interface for receiving path setup requests with bandwidth, protection type, and routing policy, a path control unit for computing the route designated by the path setup request and, allocating resources, using topological information stored in the controller, and a path setup interface to setup the route recommended by the path control unit. The path control section may compute the routes for path and allocate network and/or computer resources based on the available resource and ambient condition constraints of the apparatus using the abstracted topological information from the network site controller.

The traffic flow control section may direct traffic flows over established paths. The traffic flow control section may include a flow query interface for receiving flow resolution request; a flow control unit to control traffic based on the statistical and ambient information; and a flow setup interface to setup flow in apparatus. The traffic flow control section may manage traffic flow streams (flow switching, filtering, load-balancing, and policing/shaping) based on the topological information summarized by network abstraction (e.g., extracting resource information and ambient conditions into topological information between apparatus levels and network site levels and, network site levels and wide area network levels).

Another exemplary aspect of the present invention is directed to a network control method (e.g., path control method). The method includes a network abstraction method which extracts resource information and ambient conditions into topological information between apparatus levels and network site levels and, network site levels and wide area network levels, a path control which controls paths based on abstracted topological information, and a cooling system control which updates the setting of cooling systems based on heat emission information from the apparatus. The path control computes the path route and allocates resources based on the topological information summarized by the network abstraction, and if ambient conditions are changed as a result of path control, then the cooling system control updates the setting of cooling system.

Another exemplary aspect of the present invention is directed to a network control method (e.g., traffic flow control method). The method includes network abstraction which extracts resource information and ambient conditions into topological information between apparatus levels and network site levels and, network site levels and wide area network levels, a traffic flow control which controls traffic flow based on statistical and ambient information, and a cooling system control which updates the setting of the cooling system based on heat emission information from the apparatus. The traffic flow control manages traffic flow streams (flow switching, filtering, load-balancing, and policing/shaping) based on the topological information summarized by the network abstraction.

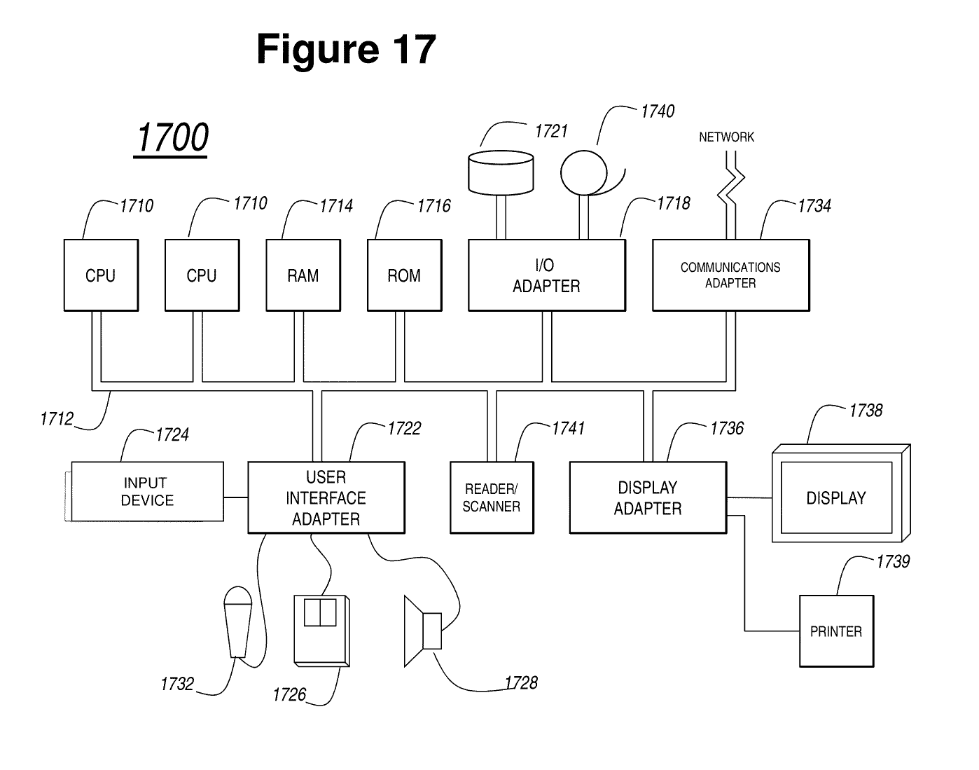

Referring again to the drawings, FIG. 17 illustrates a system 1700 including a typical hardware configuration which may be used for implementing a control system (e.g., control system 100), and method (e.g., method 200, 1200, 1400, 1600) of controlling a network, according to an exemplary aspect of the present invention.

The configuration of the system 1700 has preferably at least one processor or central processing unit (CPU) 1710. The CPUs 1710 are interconnected via a system bus 1712 to a random access memory (RAM) 1714, read-only memory (ROM) 1716, input/output (I/O) adapter 1718 (for connecting peripheral devices such as disk units 1721 and tape drives 1740 to the bus 1712), user interface adapter 1722 (for connecting an input device (e.g., keyboard) 1724, mouse 1726, speaker 1728, microphone 1732 and/or other user interface device to the bus 1712), a communication adapter 1734 for connecting an information handling system to a data processing network, the Internet, an Intranet, a personal area network (PAN), etc., and a display adapter 1736 for connecting the bus 1712 to a display device 1738 and/or printer 1739. Further, an automated reader/scanner 1741 may be included. Such readers/scanners are commercially available from many sources.

In addition to the system described above, a different aspect of the invention includes a computer-implemented method for performing the method (e.g., method 200, 1200, 1400, 1600) of controlling a network, according to an exemplary aspect of the present invention. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including non-transitory, signal-bearing media tangibly embodying a program of machine-readable instructions executable by a digital data processor to perform the above method.

Such a method may be implemented, for example, by operating the CPU 1710 to execute a sequence of machine-readable instructions. These instructions may reside in various types of non-transitory, signal bearing media.

Thus, this aspect of the present invention is directed to a programmed product, including signal-bearing media tangibly embodying a program of machine-readable instructions executable by a digital data processor incorporating the CPU 1710 and hardware above, to perform the method of the invention.

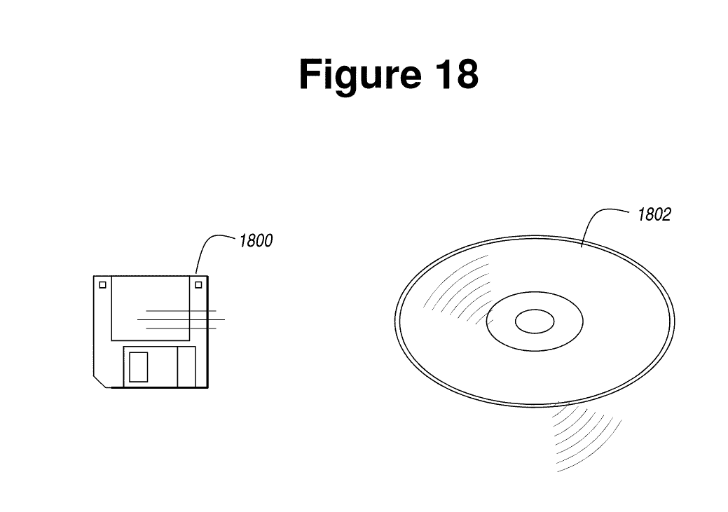

This non-transitory, signal-bearing media may include, for example, a RAM contained within the CPU 1710, as represented by the fast-access storage for example. Alternatively, the instructions may be contained in another non-transitory, signal-bearing media, such as a magnetic data storage diskette 1800 or compact disc 1802 (FIG. 18), directly or indirectly accessible by the CPU 1710.

Whether contained in the computer server/CPU 1710, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other tangible signal-bearing media (e.g., non-transitory media). In an illustrative embodiment of the invention, the machine-readable instructions may comprise software object code, compiled from a language such as C, C++, etc.

Thus, an exemplary aspect of the present invention is directed to a programmable storage medium tangibly embodying a program of machine-readable instructions executable by a digital processing apparatus to perform a method of controlling a network (e.g., method 200, 1200, 1400, 1600).

With its unique and novel features, the present invention may provide a control system and method of controlling a network which may reduce (e.g., minimize) total energy consumption in the network.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive method and system is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A control system for controlling a network including a plurality of network apparatuses, the control system comprising:
a network site controller for controlling a cooling system in the network and extracting network resource and ambient information from the plurality of network apparatuses into topological information; and
a network controller for controlling the plurality of network apparatuses based on the topological information.

2. The control system of claim 1, wherein the network controller comprises a path controller unit comprising:
a path setup request interface for receiving a path setup request;
a path control unit for computing a route designated by the path setup request and allocating a network apparatus of the plurality of network apparatuses based on available resource and ambient condition constraints of the network apparatus using the topological information; and
a path setup interface to setup the route computed by the path control unit.

3. The control system of claim 1, wherein the network controller comprises a traffic flow controller comprising:
a flow query interface for receiving flow resolution request;
a flow control unit for controlling a traffic flow based on the topological information; and
a flow setup interface to setup the traffic flow in a network apparatus of the plurality of network apparatuses.

4. The control system of claim 1, wherein the network site controller comprises:
a resource abstraction unit for extracting the network resource and ambient information into the topological information.
a location and profile management unit for managing location and profile of the plurality of network apparatuses;
a temperature management unit for monitoring a temperature of the plurality of network apparatuses and a temperature of a room housing the plurality of network apparatuses; and
a cooling system interface for requesting a change of a setting in the cooling system.

5. A network comprising:
a cooling system for removing heat energy generated by a plurality of network apparatuses;
a network site controller for controlling the cooling system and extracting network resource and ambient information from the plurality of network apparatuses into topological information; and
a network controller which controls the plurality of network apparatuses based on the topological information.

6. The network of claim 5, wherein a network apparatus of the plurality of network apparatuses comprises:
a cooling module which measures a first temperature of a coolant at a first position on the device, and a second temperature of the coolant at a second position on the device, and measures heat energy emitted from the network by comparing the first and second temperatures; and
a monitoring module which collects statistical information on at least one of a flow of traffic in a network and a load on a server in the network.

7. The network of claim 6, wherein the monitoring module comprises a heat emission profiler for profiling a heat emission of the network apparatus and calculating a heat absorption capacity which indicates an acceptable bandwidth or computation load for the network apparatus,
wherein the network controller regulates a path in the network by allocating the plurality of network apparatuses based on available resource and heat absorption capacity constraints of the plurality of network apparatuses using the topological information.

8. The network of claim 7, wherein if the network site controller determines that a total heat energy emitted from the network apparatus is exceeding a heat removing capacity of the cooling system, then the site controller changes a setting of the cooling system to enhance a heat removing capability in the cooling system.

9. The network of claim 7, wherein if the network controller fails to find a route for a path due to a heat absorption capacity constraint, then the network controller decreases or ignores a constraint to setup a path along a possible route, and changes a setting of the cooling system.

10. The network of claim 7, wherein the plurality of network apparatuses are located at a plurality of network sites, the network controller allocates the network apparatus by regulating a heat emission from another network apparatus which is located adjacent to the network apparatus in a network site of the plurality of network sites.

11. The network of claim 7, wherein the network controller uses heat absorption capacity in node/link attributes as a path computation cost, by allocating a network apparatus along a path with a maximum sum of heat absorption capability.

12. The network of claim 7, wherein the network site controller computes a temperature difference between an outside temperature and a room temperature, and the network controller uses the temperature difference as a path computation cost and allocates a network apparatus along a path with a minimum sum of the temperature difference.

13. A network apparatus comprising:
a cooling module which measures a first temperature of a coolant at a first position on the device, and a second temperature of the coolant at a second position on the device, and measures heat energy emitted from the device by comparing the first and second temperatures; and
a monitoring module which collects statistical information on at least one of a flow of traffic in a network and a load on a server in the network.

14. The network apparatus of claim 13, further comprising:
a memory for storing temperature profile information; and
a calculator for calculating a heat absorption capacity using a current ambient condition acceptable for at least one of the traffic and the load.

15. A method of controlling a network comprising:
removing heat energy generated by a plurality of network apparatuses in a network, by using a cooling system;
controlling the cooling system in the network and extracting network resource and ambient information from the plurality of network apparatuses into topological information; and
controlling the plurality of network apparatuses based on the topological information.

16. The method of claim 15, wherein the extracting of the resource information and ambient conditions comprises extracting the resource information and ambient conditions between a network device level and network site level, and between a network site level and a network level.

17. The method of claim 15, wherein the cooling of the system comprises updating a setting of the cooling system based on heat emission information from a network apparatus of the plurality of network apparatuses.

18. The method of claim 15, wherein the controlling of the network comprises computing a path route and allocating a network apparatus of the plurality of network apparatuses based on the topological information, and if an ambient condition is changed, then updating a setting of cooling system.

19. The method of claim 15, wherein the controlling of the network comprises controlling traffic flow in the network based on statistical and ambient information, and managing a stream of the traffic flow in the network based on the topological information.

20. A programmable storage medium tangibly embodying a program of machine-readable instructions executable by a digital processing apparatus to perform a method of controlling a network according to claim 15.
